(19) United States
(12) Patent Application Publication
(10) Pub. No.: US 2026/0104730 A1
(43) Pub. Date: Apr. 16, 2026

(54) MULTIFUNCTIONAL CARRYING BAG

(71) Applicant: OXTI Pte Ltd, Singapore (SG)

(72) Inventor: YU-LIN LIN, Singapore (SG)

(21) Appl. No.: 18/916,685

(22) Filed: Oct. 15, 2024

(51) Int. Cl. G06F 1/16

(52) U.S. Cl. CPC G06F 1/1607; G06F 1/1628

(57) ABSTRACT

A multifunctional carrying bag includes a bag body, which is formed with a receiving space and includes a display fixed thereto; a solid-state battery, which is arranged in the receiving space and is electrically connected to the display; and an input device, which is arranged in the receiving space and is electrically connected to the display and the solid-state battery. The solid-state battery is provided with at least one charging connection port. The solid-state battery and the input device are received in the receiving space, and the bag body can be collapsed and closed for easy portability, and the solid-state battery can be used to charge an external electronic device (such as mobile devices including mobile phones, notebook computers, tablet computers, and POS machines), increasing practicality and convenience.

### BACKGROUND OF THE INVENTION

### (a) Technical Field of the Invention

The present invention relates to a carrying bag, and more particularly to a multifunctional carrying bag that comprises a solid-state battery.

### (b) Description of the Prior Art

Portable devices generally refer to electronic data processing devices that are light in weight, convenient in size, and easy for humans to carry and use, such as notebook computers, which are convenient for a single person to operate and carry, and do not need to be connected to a power supply for a long time.

For example, Taiwan Utility Model M329804 discloses a “portable computer, which comprises a computer body. The computer body is provided with a casing. A display panel is provided on a front side of the casing. A speaker is provided on a side of the display panel. A power switch, a power socket, and a connection socket group are arranged around the casing. The connection socket group includes a plurality of USB sockets and a network cable socket.

However, portable devices face the problem of power consumption. Taking the notebook computers as an example, the batteries of the notebook computer are usually lithium batteries, which can generally provide 2 to 4 hours of operation. Further, for carrying, a notebook computer bag must be provided to receive the notebook computer and a notebook computer portable power bank (which is usually lithium batteries), so that carrying is cumbersome and the weight is heavy.

### SUMMARY OF THE INVENTION

To achieve the above objective, the present invention provides a multifunctional carrying bag, which comprises: a bag body, the bag body being formed with a receiving space, the bag body comprising a display fixed thereto; a solid-state battery, the solid-state battery being arranged in the receiving space, the solid-state battery being electrically connected to the display; and an input device, the input device being arranged in the receiving space, the input device being electrically connected to the display and the solid-state battery.

In the above, the solid-state battery is provided with at least one charging connection port.

In the above, the display comprises at least one connection port.

In the above, the electrical connection is wired electrical connection or wireless electrical connection.

In the above, the input device comprises a keyboard.

In the above, the bag body comprises a first sheet member and a second sheet member, the first sheet member being provided with a first connection member, the second sheet member being provided with a second connection member corresponding to the first connection member.

The solid-state battery and the input device are received in the receiving space, and the bag body can be collapsed and closed for easy portability, and the solid-state battery can be used to charge an external electronic device (such as mobile devices including mobile phones, notebook computers, tablet computers, and POS machines), increasing practicality and convenience.

### BRIEF DESCRIPTION OF THE DRAWINGS

FIG. 1 is an exploded view of a multifunctional carrying bag according to the present invention.

FIG. 2 is a perspective view of the multifunctional carrying bag according to the present invention.

FIG. 3 is a schematic view illustrating a solid-state battery included in the present invention is charging electrical power to an external electronic device.

FIG. 4 is a perspective view showing the multifunctional carrying bag according to the present invention in a collapsed and closed condition.

### DETAILED DESCRIPTION OF THE PREFERRED EMBODIMENTS

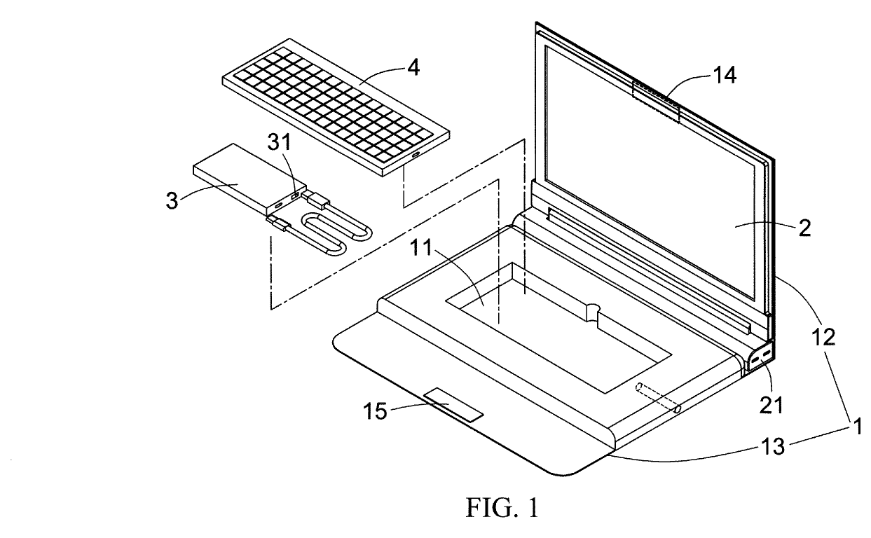

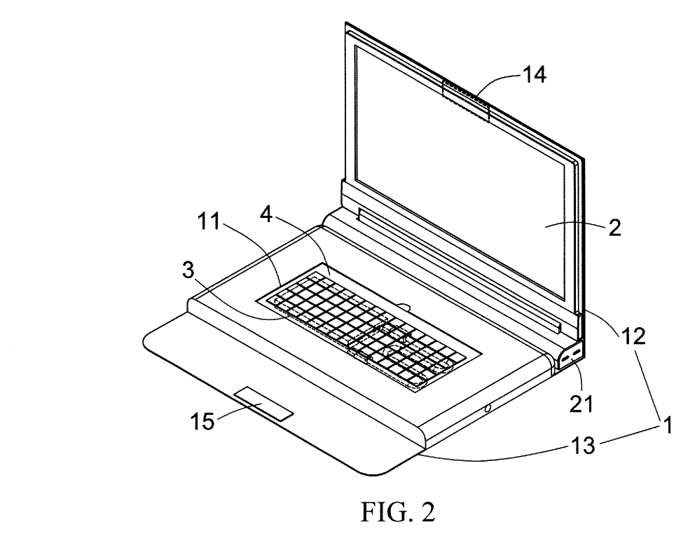

Referring to FIGS. 1 and 2, the present invention provides a multifunctional carrying bag, which comprises:

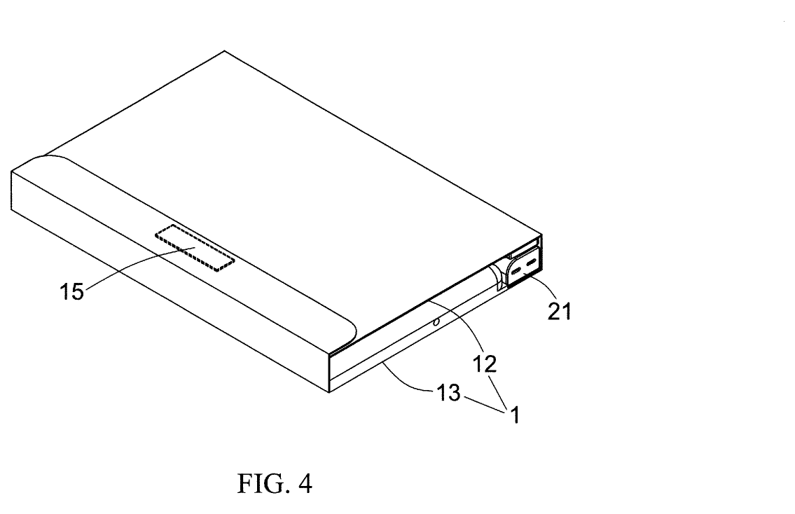

a bag body 1, wherein the bag body 1 is formed with a receiving space 11, and the bag body 1 comprises a display 2 fixed thereto (including fixing measures such as soldering or adhesive bonding). In this, the bag body 1 comprises a first sheet member 12 and a second sheet member 13. The first sheet member 12 is provided with a first connection member 14, and the second sheet member 13 is provided with a second connection member 15 corresponding to the first connection member 14. The first connection member 14 is connectable with the second connection member 15 to have the first sheet member 12 and the second sheet member 13 connected to each other for collapsing and closing of the bag body 1 (see jointly FIGS. 1 and 4, where FIG. 4 is a schematic view illustrating the collapsed and closed condition). The first connection member 14 and the second connection member 15 can be a buckle and a slot that are engageable with each other, or magnets that attract each other, or two Velcro felts that adhere to each other, but are not limited to this.

The display 2 can be a liquid crystal display (LCD), a light-emitting diode display (LED Display), an organic light emitting diode display (OLED Display), a thin film transistor-liquid crystal display (TFT-LCD), an electro-phoretic display (EPD), or a plasma display panel (PDP), but not limited to this. The display 2 may comprise at least one connection port 21. The connection port 21 can be a Type-C universal serial bus (USB Type-C) connection port, a high definition multimedia interface (HDMI) connection port, a display port (DP) interface, a video graphics array (VGA) connection port, or a digital visual interface (DVI) connection port, but not limited thereto. The connection port 21 is connectable with an external electronic device 5 to carry out transmission of signals (specifically image signals) with respect to the external electronic device 5. The display 2 can be an all-in-one (AIO) personal computer (PC), wherein a central processing unit (CPU), a memory, and a hard disk drive are integrated and embedded in the interior of the display 2.

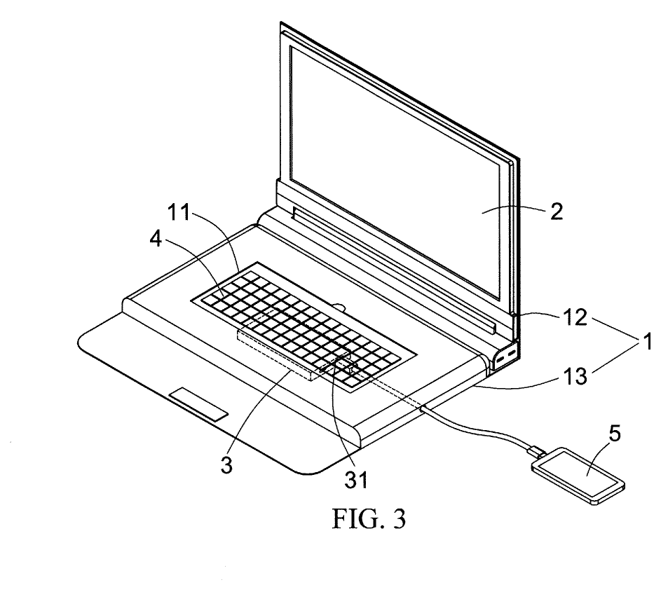

a solid-state battery 3, wherein the solid-state battery 3 is arranged in the receiving space 11, and the solid-state battery 3 is electrically connected to the display 2. In this, the solid-state battery 3 is a battery that uses solid-state electrodes and a solid-state electrolyte. The fundamental difference of the solid-state battery 3 from the liquid state batteries is that the state of electrolyte is different, where because the solid-state battery 3 does not have a liquid electrolyte but a solid electrolyte, the interior is denser, the volume is smaller, and the energy density is increased. Liquid state batteries, such as lithium batteries, are composed of organic solvents (liquid electrolytes) and conductive salts. Most safety issues with lithium batteries are caused by the flammability of the organic solvents. In addition, the side reactions of the organic solvents and the conductive salts can cause capacity fading and aging of the lithium batteries. The characteristics of the solid-state battery 3 are as follow: (1) High safety: as a solid electrolyte is used, there is no problems of leakage pollution and flammability and explosion. (2) High energy density: the positive and negative electrodes can be made of materials of higher energy density. (3) Small volume: as there is no liquid electrolyte, the volume can be reduced, and since no liquid electrolyte is involved, storage becomes easier. (4) Fast charging speed: the solid electrolyte has higher ionic conductivity, so that charging speed is faster and charging waiting time is shortened. The solid-state battery 3 may be provided with at least one charging connection port 31, and the charging connection port 31 is used to connect the external electronic device 5 and to charge the external electronic device 5 (shown in FIG. 3). The solid-state battery 3 is electrically connected to the display 2, and the electrical connection can be a wired electrical connection or a wireless electrical connection. The wired electrical connection is that the solid-state battery 3 is electrically connect to the display 2 through wires, and the wireless electrical connection is that the solid-state battery 3 and the display 2 are connected through Bluetooth or Near Field Communication (NFC), Wireless Fidelity (WiFi), second generation mobile communication technology (2G), General Packet Radio Service (GPRS), third generation mobile communication technology (3G), and fourth generation modern mobile communication technology (4G).

an input device 4, wherein the input device 4 is arranged in the receiving space 11, and the input device 4 is electrically connected to the display 2 and the solid-state battery 3. In this, the input device 4 can be a keyboard, but not limited to this. The input device 4 is electrically connected to the display 2 and the solid-state battery 3, and the electrical connection can be wired electrical connection or wireless electrical connection.

In the present invention, the solid-state battery 3 and the input device 4 are received in the receiving space 11, and the bag 1 can be collapsed and closed for easy portability, and the solid-state battery 3 can be used to charge an external electronic device 5 (such as mobile devices including mobile phones, notebook computers, tablet computers, and POS machines), increasing practicality and convenience. Moreover, the solid-state battery 3 can improve the safety of use, is small in size and has a fast charging speed. Further, due to the high energy density, the solid-state battery 3 has a higher amount of battery storage energy, so as not only to increase the endurance of use, but also to have sufficient power for charging an external electronic device 5.

I claim:

1. A multifunctional carrying bag, comprising:
a bag body, the bag body being formed with a receiving space, the bag body comprising a display fixed thereto;
a solid-state battery, the solid-state battery being arranged in the receiving space, the solid-state battery being electrically connected to the display; and
an input device, the input device being arranged in the receiving space, the input device being electrically connected to the display and the solid-state battery.

2. The multifunctional carrying bag according to claim 1, wherein the solid-state battery is provided with at least one charging connection port.

3. The multifunctional carrying bag according to claim 1, wherein the display comprises at least one connection port.

4. The multifunctional carrying bag according to claim 1, wherein the electrical connection is wired electrical connection or wireless electrical connection.

5. The multifunctional carrying bag according to claim 1, wherein the input device comprises a keyboard.

6. The multifunctional carrying bag according to claim 1, wherein the bag body comprises a first sheet member and a second sheet member, the first sheet member being provided with a first connection member, the second sheet member being provided with a second connection member corresponding to the first connection member.
